(19) United States
(12) Patent Application Publication
(10) Pub. No.: US 2009/0124209 A1
(43) Pub. Date: May 14, 2009

(54) METHODS AND SYSTEM FOR CONFIGURATION OF BROADBAND OVER POWER LINES

(76) Inventor: Michael Keselman, San Ramon, CA (US)

Correspondence Address: DICKSTEIN SHAPIRO LLP, 1825 EYE STREET NW, Washington, DC, 20006-5403, US

(21) Appl. No.: 12/268,178

(22) Filed: Nov. 10, 2008

Related U.S. Application Data
(60) Provisional application No. 60/996,268, filed on Nov. 8, 2007.

(51) Int. Cl. H04B 17/00

(52) U.S. Cl. 455/67.13

(57) ABSTRACT

Disclosed embodiments provide methods and systems for the configuration of broadband over power lines. The configuration entails calculating a desired distance between nodes by measuring a noise floor on a power line, measuring a signal power level on the power line and determining the desired distance based on a target signal-to-noise ratio.

This application claims the benefit of U.S. Provisional Appl. No. 60/996,268 filed Nov. 8, 2007, the entire disclosure of which is incorporated herein by reference.

### FIELD OF THE INVENTION

Embodiments are directed towards the configuration of broadband over power lines.

### BACKGROUND OF THE INVENTION

A broadband over power line (“BPL”) system delivers broadband data signals to end users using the electricity power distribution network that simultaneously supplies electrical power. BPL systems can be implemented using either overhead or underground power lines.

BPL systems use radio signals sent over medium and low voltage power lines to deliver data. A data signal is modulated with a radio-frequency (RF) signal at a first location (or node) and coupled to a medium-voltage power line serving as a transmission channel. At a second node the radio-frequency signal is coupled from the medium-voltage power line to a demodulator for converting the modulated signal back to a data signal. Data is sent from the second node to the first node in a similar manner, typically using a different band of frequencies. This full-duplex broadband service between the locations may simultaneously supply a variety of communication needs, such as telephone service, video service, Internet service, and other services requiring high-speed data transfers.

BPL nodes include, but are not limited to, injectors or concentrators, repeaters or regenerators, and extractors. Injectors tie the Internet backbone with medium-voltage power lines typically using fiber or T1 lines. Regenerators amplify the signal strength to carry the data signals over medium-voltage power lines for farther distances. Regenerators are connected to power lines via a device called a coupler which safely connects low voltage electronic devices like regenerators to high voltage lines. Finally, extractors provide the interface between the medium-voltage power lines and the low-voltage power lines feeding end users.

Most modern BPL systems operate with a carrier frequency range of approximately 1-30 MHz. In contrast, electricity flows over power lines at approximately 50 or 60 Hz. Thus, there is no danger of interference between electricity and data flows in the power lines. At this bandwidth, BPL systems could theoretically provide tens of megabits per second (Mbps) of throughput. But BPL technology faces many technical challenges including high attenuation over long distances and signal interferences that limit the quality and throughput of the communication signal.

One technical challenge faced by BPL technology is the attenuation of the broadband signal over long distances as it goes through the power line. A BPL signal suffers from higher attenuation at higher frequencies. Power line components such as transistors, transformers and converters each contribute to the signal degradation in a BPL system. Though boosting the broadband signal is one solution to attenuation, FCC regulatory emissions limits on signal levels restrict boosting the transmission signal. Therefore, regenerators or repeaters are used en-route to compensate for the attenuation.

Another technical challenge faced by BPL technology is the loss of the signal due to the many noise sources in a BPL system. Potential high interference from noisy loads and devices abruptly turning on and off make power lines inherently very noisy. Moreover, a signal sent at a particular frequency at one node may interfere with a signal using the same frequency at another node where the same frequency is used over relatively short distances. The potential for frequency interference restricts placing the nodes too close together while attenuation of the signal over long distances restricts placing the nodes too far from each other.

Conventional methods of assigning distances between nodes look only at the power loss to determine acceptable distances between nodes. These methods assume that noise does not function over short distances, i.e., less than one mile, and does not affect the performance of BPL systems. In reality, the combination of high attenuation and a large noise source nearby may cause a very low signal-to-noise ratio (SNR) at a node. Thus, optimum placement of BPL nodes is critical to the success of using power lines to provide broadband access.

Placing nodes closer to each other improves network performance, but increases the cost of the deployment and may also increase interference between adjacent nodes. Spacing nodes farther apart will reduce the capacity and the speed of the BPL network. Accordingly, there is a need for calculating the desired distance between nodes in a broadband over power line system.

### BRIEF DESCRIPTION OF THE DRAWINGS

FIG. 1 is a schematic diagram of an embodiment of a broadband over power line system constructed in accordance with the invention;

FIG. 2A is a plot from a spectrum analyzer showing signal power along a spectrum of frequencies;

FIG. 2B is a plot of a broadband over power line signal, noise floor level, and target signal-to-noise level in relation to a calculated desired distance between nodes in a broadband over power line system in accordance with disclosed embodiments;

FIG. 3 illustrates a method of calculating the desired distance between nodes in a broadband over power line system in accordance with a disclosed embodiment;

FIG. 4 illustrates a second method of calculating the desired distance between nodes in a broadband over power line system in accordance with another disclosed embodiment; and

FIG. 5 is a schematic diagram of another embodiment of the system in FIG. 1.

### DETAILED DESCRIPTION OF THE INVENTION

In the following detailed description, reference is made to the accompanying drawings, which form a part hereof and show by way of illustration specific embodiments in which the present invention may be practiced. These embodiments are described in sufficient detail to enable those skilled in the art to practice them, and it is to be understood that other embodiments may be utilized, and that structural, logical, processing, and electrical changes may be made. The progression of processing steps described is an example; however, the sequence of steps is not limited to that set forth herein and may be changed as is known in the art, with the exception of steps necessarily occurring in a certain order.

Disclosed embodiments define methods for calculating the desired distance between nodes in a broadband over power line (“BPL”) system. The nodes in a BPL system may include, but are not limited to, BPL components such as regenerators, extractors, and injectors. BPL components are connected to power lines via a device called a coupler, which safely connects low-voltage BPL components with high-voltage power lines. The processes described herein may be implemented in an overhead or an underground power line system. In an overhead power line system, nodes are typically located at electric utility poles, whereas, in an underground power line system, the nodes can be placed at any location where the power cables may be accessed such as where pull-boxes, man-holes, or transformers are located.

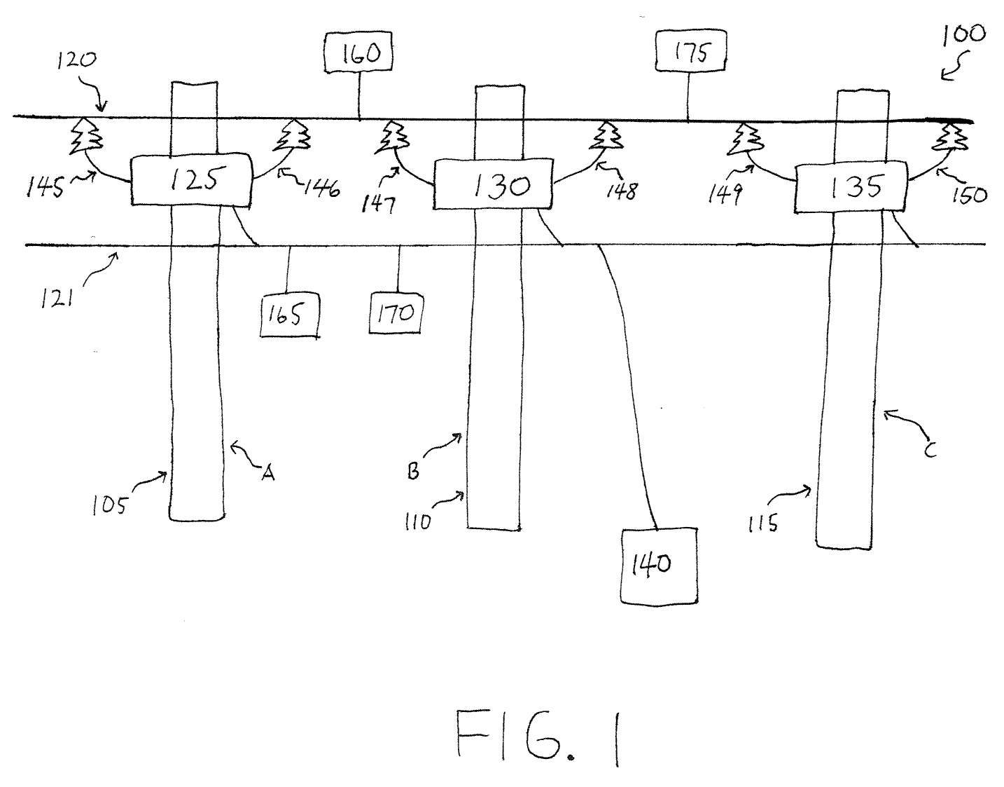

FIG. 1 illustrates a schematic diagram of a BPL system 100 constructed in accordance with an embodiment described herein. BPL system 100 includes the following: first, second, and third utility poles 105, 110, 115; a medium-voltage power line 120; a low-voltage power line 121; first, second, and third BPL regenerators 125, 130, 135; and a customer site 140 connected to the low-voltage power line 121 near the second regenerator 130 for receiving the broadband signal. First through sixth BPL couplers 145-150 are connected between the BPL regenerators 125, 130, 135 and the medium-voltage power line 120.

BPL system 100 further includes components 160, 165, 170, 175, which can be any other components found in a power grid system and connected to any part of the grid, for example, transformers, arresters, reclosers, and taps. Each respective regenerator 125, 130, 135 represents a node A, B, C. As shown, each node is typically located at a respective utility pole 105, 110, 115 and has two couplers 145-150 connected to it, one for receiving the BPL signal at a first frequency band, and the other for transmitting the BPL signal at a second frequency band, the second frequency band commonly but not necessarily different from the first. It should be noted that every utility pole in a power grid may not be a BPL node. The medium-voltage power line 120 may be a single-phase or multi-phase power line, such as a three-phase power line.

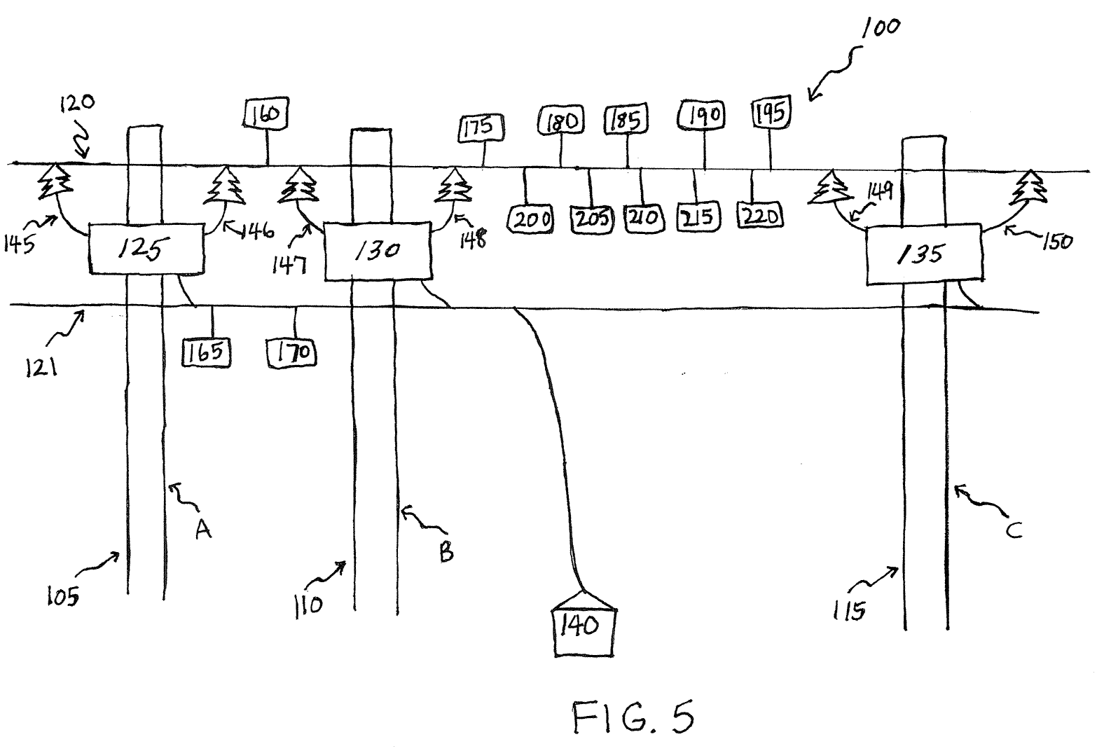

In a BPL system, such as the embodiments shown in FIGS. 1 and 5, a BPL signal is generated by a BPL regenerator 125 at one node A and sent down the electric grid to another BPL regenerator 130 at another node B. Each additional line component 120-175, as well as the distance a signal travels on the power line itself, adds attenuation to the BPL signal. Additionally, the attenuation of a BPL signal is affected by the carrier frequency. Most modern BPL systems operate with carrier frequencies in the range of approximately 1 to 30 MHz. The three frequency bands used on most BPL backbones are mode 1 (3-13 MHz), mode 2 (13.5-23.5 MHz) and mode 3 (24-34 MHz). The respective attenuation of each line component can be measured or obtained from previously known information, and is dependent upon factors including, but not limited to, the frequency band, the type of the equipment, manufacturers, and connectivity to the electrical line.

Every power line, including power line 120, has its own unique basic level of noise called the noise floor. The noise floor is the noise measured on a power line in the absence of the BPL signal. Because noise normally occupies a wide range of frequencies and is fairly constant across the range of frequencies, it is possible to measure the noise floor in the presence of a BPL signal by measuring the noise outside of the BPL frequency band. For example, the measurements may be done by using a spectrum analyzer connected to a BPL coupler 145-150.

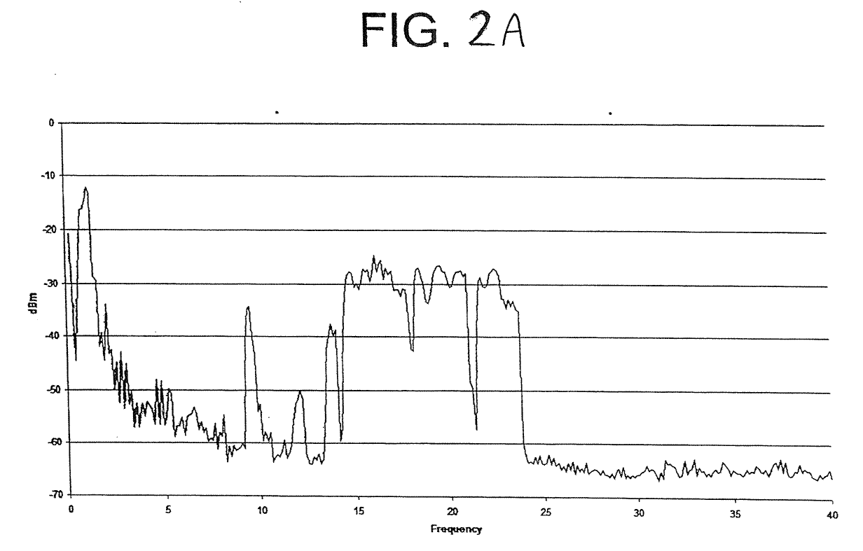

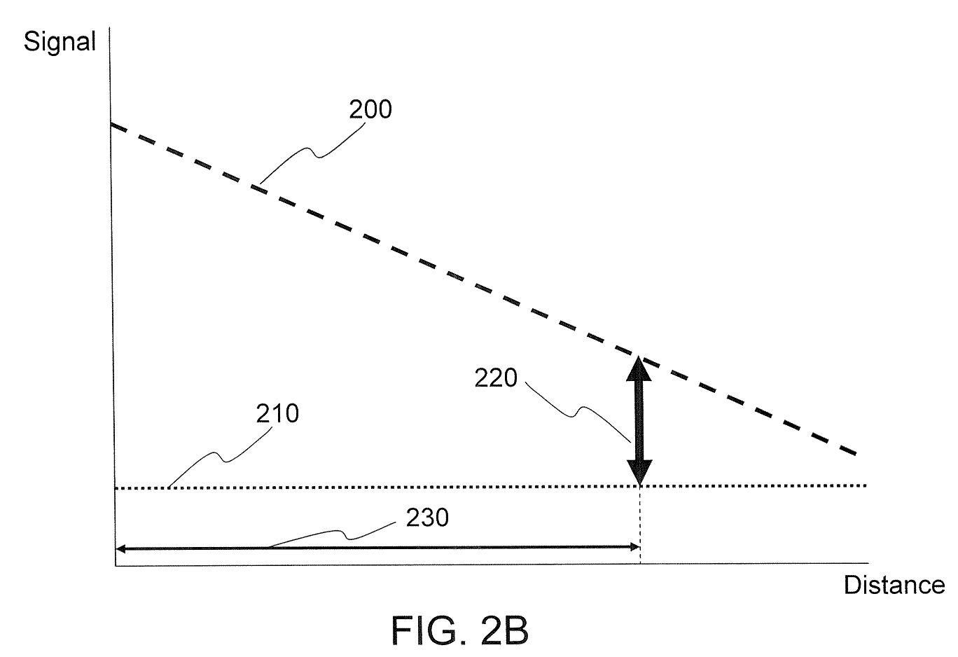

FIG. 2A is a plot from a spectrum analyzer showing signal power and noise on the medium-voltage power line 120 at various frequencies in the 0 to 40 MHz range. FIG. 2A shows that the BPL signal is present from approximately 14 to 24 MHz. The signal above 24 MHz represents the noise floor, which in this case is approximately −65 dBm. Therefore, the BPL signal in this example operates in mode 2 as described above. In FIG. 2A, the peaks between 3 and 13 MHz represent interference at least partially from mode 1 BPL frequencies upstream on the medium-voltage power line 120. Below 3 MHZ, the signals come from noise and signals from other non-BPL sources.

Signal-to-noise ratio (SNR) is the ratio of a BPL signal to the noise level present on a power line. SNR is a key characteristic that indicates an equipment's ability to extract useful signals from a noisy signal on the power line. The SNR is highest at the beginning of a power line where the BPL signal is strongest and drops as the signal travels down the line. In FIG. 2A, the SNR is 35 dB, which is the difference between the BPL signal level (−30 dBm) and the noise floor (−65 dBm). The values shown in FIG. 2A and used in the above example to derive the SNR are only exemplary. The numbers that may be used to derive a SNR are not limited to that set forth herein and may be changed as are known in the art.

Disclosed embodiments provide methods of calculating the desired distance between nodes in a BPL system using a measured BPL signal and noise floor level with a target SNR level that is appropriate for the BPL equipment. FIG. 2B illustrates the signal strength of the BPL signal 200, noise floor level 210, and target SNR level 220 in relation to the calculated desired distance 230 between BPL nodes. As noted above, the BPL signal 200 attenuates over long distances as it goes through the power line 120 (FIG. 1) and the noise floor level 210 is present in every power line, including power line 120. As shown in FIG. 2B, the target SNR level for a BPL equipment such as BPL regenerator 125 (FIG. 1) will determine the calculated desired distance 230 between two BPL nodes on the power line 120.

The described methods can be performed by a system comprising a processor and a storage medium, such as a computer. The computer is configured to receive measured values from the BPL system, either from measurement equipment on the BPL system or via manual inputting of the values. The computer is configured to output the calculated results, and/or display the calculated results on a screen. A computer program that causes the computer to perform one or more of the steps described above can be stored on a computer-readable storage medium, and executed by the computer.

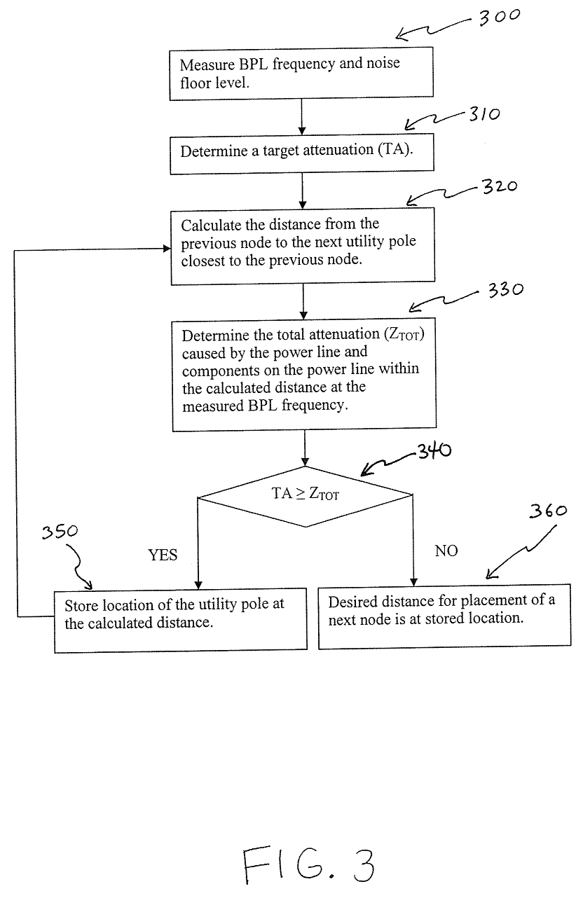

Turning to FIG. 3, one embodiment is now described in greater detail. FIG. 3 is a flowchart illustrating a computerized method of calculating the desired distance between nodes in a broadband over power line system. Prior to calculating the distance between nodes, three input parameters need to be determined: the BPL frequency band, the noise floor level, and a target attenuation level. At step 300, the BPL frequency band and the noise floor level on the medium-voltage power line 120 is measured. As noted above in relation with the description of FIG. 2A, it is possible to measure both parameters using a spectrum analyzer connected to a BPL coupler 145-150. The measured values of the BPL frequency band and the noise floor level are stored in a storage medium, such as a computer memory.

At step 310, a target attenuation level is determined. Each equipment manufacturer typically defines minimum SNR levels for their equipment. While the equipment will operate at lower SNR levels, the network performance will significantly degrade and error may appear in transmitted data. Since the primary concern is the BPL backbone, 40 dB will be used as the target SNR for this desired embodiment. The target SNR can be used to determine a target attenuation level as follows:

Target SNR=BPL signal power−N−TA,

where N represents the noise floor and TA represents the target attenuation level. Assuming the BPL equipment to be placed at the nodes can transmit −50 dBm/Hz or 20 dBm for 10 MHz band and accounting for a 12 dBm FCC power mask, the effective BPL signal power is 8 dBm. Next, with the target SNR at 40 dB, the target attenuation can be calculated as −32 dBm−N. Finally, if the noise floor on the medium-voltage power line 120 is −65 dBm, the target attenuation is 33 dB. The values that may be used to derive a target attenuation is not limited to that set forth herein and may be changed as is known in the art.

If the measured noise floor level is very low, a high target attenuation can result from the aforementioned equation that is below the BPL equipment's sensitivity rating. Therefore, the target attenuation should be limited by the sensitivity of the BPL equipment. For instance, equipment used in the backbone of BPL systems perform well with a 45 dB attenuation between a transmitting BPL regenerator 125-135 and a receiving BPL regenerator 125-135. The FCC power mask reduces this number by 12 dB and makes the maximum attenuation 33 dB. Therefore, if the target attenuation TA based on the measured noise floor is above 33 dB, the target attenuation should be limited to 33 dB. As noted above, the values used in the above example to derive the target attenuation are only exemplary and not limited to that set forth herein.

Returning to FIG. 3, in step 320, the distance from the previous node on the medium-voltage power line 120 to the next location down the power line where a node may be placed is calculated by the processor. The regenerators 125-135 cannot be more than 10 to 20 feet from a coupler 145-150, and therefore from the power line 120. To fulfill that requirement, overhead line regenerators are typically located on electric utility poles whereas underground line regenerators are located wherever the underground power cable may be accessed such as in a cable box, pull box, man-hole, or transformer. If the desired distance does not match a utility pole or cable box location, the regenerator is placed at the location closest to the desired distance, but where the distance to the previous regenerator is less than the desired distance.

In step 330, the total attenuation Z_{TOT} caused by all power line components 160-175 and the attenuation for the distanced traveled on the power line itself is determined. The three-phase medium-voltage power line 120 adds approximately 5 dB attenuation per 1000 ft. The attenuation of each power line component 160-175 can be measured or specified by the component manufacturer at the measured BPL frequency from step 300. In addition, a pair of BPL couplers 145-150 are commonly connected to each BPL regenerator 125-135, and their attenuation must be added to the total attenuation as well.

Once a total attenuation is determined in step 330, a comparison is made in step 340 by the processor between the total attenuation and the target attenuation determined in step 310. If the target attenuation is greater than or equal to the total attenuation, the location of the node determined in step 320 is stored in step 350. The process returns to step 320 where the next location available for node placement is selected, and a new total attenuation Z_{TOT} is determined. Steps 320 through 350 repeat until the target attenuation is less than the total attenuation calculated in step 330. At this point in step 360, the desired distance for placement of the next node is determined as the utility pole at the stored location from step 350.

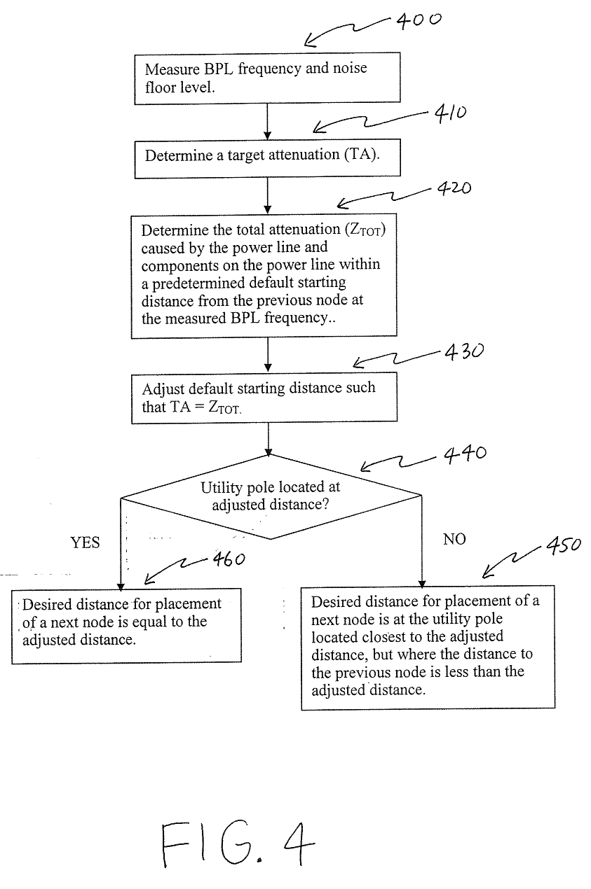

In another embodiment illustrated in FIG. 4, the calculation for the desired distance between two nodes may be calculated by the processor using a predetermined default starting distance from the location of the previous node. Like the embodiment illustrated in FIG. 3, the process illustrated in FIG. 4 begins with measuring the BPL frequency band and the noise floor level on the medium-voltage power line 120 at step 400 and determining a target attenuation level at step 410. Then, at step 420, the total attenuation Z_{TOT} caused by all power line components located within the default starting distance from the previous node and the attenuation due to the power line itself is determined at the measured BPL frequency.

At step 430, the default starting distance is adjusted such that the target attenuation equals the total attenuation determined in step 420. The desired distance for placement of the next node is at the distance where the target attenuation equals the total attenuation. Methods for adjusting a default starting distance to achieve a desired distance is illustrated below in the two applications of this desired embodiment.

Once a desired distance is determined in step 430, the process proceeds to step 440 where a determination is made as to whether a utility pole exists at the calculated desired distance. If a utility pole does exist at the calculated desired distance, then the next node is placed at the location of this pole in step 460. Conversely, if, in step 440, it is determined that a utility pole does not exist at the calculated desired distance, then, in step 450, the next node is placed at the utility pole which is closest to the calculated desired distance but where the distance to the previous node is less than the desired distance.

Two examples below will illustrate the process in FIG. 4 for calculating the desired distance between nodes using a default starting distance. The broadband over power line system in both examples operate within the frequency range of mode 1 (3-13 MHz). Both examples also use a measured noise floor of −55 dBm, a three-phase medium-voltage power line 120 with an attenuation of 5 dB per 1000 feet, and a default starting distance of 2000 feet. Each example calculates the desired distance between the second BPL regenerator 130 and the third BPL regenerator 135. In Example 1, the power line contains one overhead transformer as illustrated in FIG. 1. The power line in Example 2, however, as illustrated in FIG. 5, contains ten overhead transformers. Each transformer and each coupler has an attenuation of 0.7 dB and 4 dB, respectively, when operating in mode 1.

### EXAMPLE 1

Step 400: BPL frequency band in mode 1 and noise floor level is −55 dBm.
Step 410: Target Attenuation (TA)=−32−N=−32−(−55)=23 dB
Step 420: Couplers 147 and 148 attached to BPL regenerator 130 each add 4 dB attenuation and transformer 175 adds 0.7 dB attenuation.
   2000 feet of the power line causes 10 dB attenuation.
   Total Attenuation (Z_{TOT})=2*4+0.7+10=18.7 dB
Step 430: TA (23 dB)≠Z_{TOT} (18.7 dB)
Step 450: Since TA>Z_{TOT} whereby the difference between TA and Z_{TOT} is 4.3 dB, the default starting distance can be increased by approximately 4.3 dB/5 dB)*1000 feet=860 feet. Assuming there are no additional power line components in those 860 feet to add attenuation, the desired distance is 2860 feet from the second BPL regenerator 130.
Steps 470-490: If a utility pole exists at the desired distance of 2860 feet from the second BPL regenerator 130, then the third BPL regenerator 135 is placed at this utility pole. Otherwise, the third BPL regenerator 135 is placed at the utility pole which is closest to the desired distance, but where the distance to the second BPL regenerator 130 is less than 2860 feet.

### EXAMPLE 2

Step 400: BPL frequency band in mode 1 and noise floor level is −55 dBm.
Step 410: Target Attenuation (TA)=−32−N=−32−(−55)=23 dB.
Step 420: Couplers 147 and 148 attached to BPL regenerator 130 each add 4 dB attenuation and ten transformers 175 to 220 each add 0.7 dB attenuation.
   2000 feet of the power line causes 10 dB attenuation.
   Total Attenuation (Z_{TOT})=2*4 dB+7 dB+10 dB=25 dB
Step 430: TA (23 dB)≠Z_{TOT} (25 dB)
Step 450: Since TA<Z_{TOT}, whereby the difference between TA and Z_{TOT} is −2 dB, the default starting distance must be decreased by approximately 2 dB/5 dB)*1000 feet=400 feet. Thus, the desired distance is 1600 feet from the second BPL regenerator 130.
Steps 470-490: If a utility pole exists at the desired distance of 1600 feet from the second BPL regenerator 130, then the third BPL regenerator 135 is placed at this utility pole. Otherwise, the third BPL regenerator 135 is placed at the utility pole which is closest to the desired distance, but where the distance to the second BPL regenerator 130 is less than 1600 feet.

The above-described processes can be performed by a measuring device including a memory, processor, and an interface for measuring characteristics on a BPL network. One such example of a measuring device is described in U.S. Patent Application No. 60/996,269, the disclosure of which is incorporated herein by reference.

The above-described process can be used to configure a BPL system by either determining an initial architecture, such as described above. Alternatively, the above-described process can be used to actively configure a BPL system. For example, the above-described process can be used to monitor a BPL system, and remotely deactivate components interfaced with the power line to maintain a target signal-to-noise ratio, or create additional nodes on the BPL system (e.g., by activating additional regenerators or repeaters) to maintain a target signal-to-noise ratio.

The processes and devices in the above description and drawings illustrate examples of methods and devices of many that could be used and produced to achieve the objects, features, and advantages of embodiments described herein. For example, embodiments include receiving and transmitting the same signal frequency at each node A-C while still avoiding interference. Furthermore, the embodiments may be implemented with underground power lines. Also, as noted above, the respective attenuation of each power line component will vary based on several factors including the BPL frequency band and an equipment's minimum SNR. Thus, the embodiments are not to be seen as limited by the foregoing description of the embodiments, but only limited by the appended claims.

What is claimed as new and desired to be protected by Letters Patent of the United States is:

1. A computerized method of determining a desired distance between nodes in a broadband over power line system, said method comprising:
measuring a noise floor on a power line;
storing the measured noise floor in a memory;
measuring a signal power level on said power line;
storing the measured signal power level in the memory; and
calculating the desired distance based on a target signal-to-noise ratio, wherein the calculation is performed by a processor.

2. The method of claim 1, wherein the target signal-to-noise ratio is above a predetermined amount.

3. The method of claim 2, wherein said nodes include one or more broadband over power line components including, but not limited to, regenerators, extractors, and injectors.

4. The method of claim 3, further comprising determining a target attenuation based on the noise floor, the signal power level, and the target signal-to-noise ratio.

5. The method of claim 4, wherein the target attenuation is limited by a sensitivity value associated with a broadband over power line component attached to a node.

6. The method of claim 5, further comprising measuring the frequency band for a broadband over power line signal.

7. The method of claim 6, wherein the frequency band includes, but is not limited to, a band with frequencies in the range of 3 to 13 MHz, a band with frequencies in the range of 13.5 to 23.5 MHz, and a band with frequencies in the range of 24 to 34 MHz.

8. The method of claim 7, wherein the power line includes, but is not limited to, components such as transistors, transformers, arresters, reclosers, taps and converters; and wherein each component has an associated attenuation that is a function of the frequency band for the broadband over power line signal.

9. The method of claim 8, wherein the desired distance is based on a comparison between the target attenuation and a total attenuation caused by the power line and components on the power line.

10. The method of claim 9, wherein the desired distance is calculated between a first and a second node and the attenuation caused by components on the power line are within a predetermined default starting distance from the first node.

11. The method of claim 10, wherein the predetermined default starting distance is adjusted based on the comparison between the target attenuation and the total attenuation caused by the power line and components on the power line.

12. A broadband over power line system comprising a plurality of nodes, wherein a first of said nodes is located at a desired distance from a second of said nodes, the desired distance being based on a target signal-to-noise ratio and being determined by a computer comprising a processor for determining the desired distance, and a memory for storing the determined signal-to-noise ratio.

13. The system of claim 12, wherein the target signal to noise ratio is above a predetermined amount.

14. The system of claim 13, wherein said nodes include one or more broadband over power line components including, but not limited to, regenerators, extractors, and injectors.

15. The system of claim 14, wherein the target signal-to-noise ratio is used to determine a target attenuation.

16. The system of claim 15, wherein the power line includes, but is not limited to, components such as transistors, transformers, arresters, reclosers, taps and converters; and wherein each component has an associated attenuation that is a function of a carrier frequency for the broadband over power line signal.

17. The system of claim 16, wherein the desired distance between said first node and said second node is based on a comparison between the target attenuation and a total attenuation caused by the power line and components on the power line.

18. The system of claim 17, wherein the total attenuation caused by the power line and components on the power line is within a predetermined default starting distance from the first node.

19. The system of claim 18, wherein the predetermined default starting distance is adjusted based on the comparison between the target attenuation and the total attenuation caused by the power line and components on the power line.

20. The system of claim 12, further comprising a coupler device connecting one of said nodes to the power line and a spectrum analyzer connected to the coupler device for measuring a noise level and a signal power level.

21. The system of claim 12, wherein said power line comprises a multi-phase power line.

22. The system of claim 21, wherein said multi-phase power line includes a three-phase power line.

23. The system of claim 12, wherein the power line operates with carrier frequencies in the range of 1 to 30 MHz.

24. The system of claim 12, wherein said power line comprises an underground power line.

25. The system of claim 12, wherein said determination is used to determine an initial location of at least one of said first and second nodes.

26. The system of claim 12, wherein said determination is used to maintain a desired signal-to-noise ratio of said BPL system.

27. The system of claim 26, wherein a regenerator on said BPL system is activated according to said determination.

28. The system of claim 26, wherein one or more components of said BPL system are deactivated according to said determination.
